(19) United States
(12) Patent Application Publication
(10) Pub. No.: US 2022/0235689 A1
(43) Pub. Date: Jul. 28, 2022

(54) COMPUTER-IMPLEMENTED METHOD AND DEVICE FOR A MANIPULATION DETECTION FOR EXHAUST GAS TREATMENT SYSTEMS WITH THE AID OF ARTIFICIAL INTELLIGENCE METHODS

(71) Applicant: Robert Bosch GmbH, Stuttgart (DE)

(72) Inventors: Markus Hanselmann, Stuttgart (DE); Jens Stefan Buchner, Bietigheim-Bissingen (DE); Thilo Strauss, Ludwigsburg (DE); Thomas Branz, Stuttgart (DE)

(21) Appl. No.: 17/581,416

(22) Filed: Jan. 21, 2022

(30) Foreign Application Priority Data
Jan. 28, 2021 (DE) 10 2021 200 789.9

(51) Int. Cl. F01N 11/00; G06N 3/08

(52) U.S. Cl. CPC F01N 11/00; G06N 3/08; F01N 2900/0422; F01N 2900/0402; F01N 2550/24

(57) ABSTRACT

A computer-implemented method for detecting a manipulation of a technical device. The method includes: providing time characteristics of operating variables having system variable(s) and/or a correction variable for an intervention in the technical device which correspond to time series of values of the operating variables for each of consecutive time steps; using a data-based manipulation detection model in each current time step to ascertain one or more output variable(s) that correspond at least to a portion of the operating variables as a function of input variables which include at least a portion of the operating variables. The manipulation detection model includes an autoencoder having a first recurrent neural network, a prediction model having a second recurrent neural network, and an evaluation model, the outputs of the autoencoder and the prediction model being combined with one another and then conveyed to an evaluation model for an ascertainment of the output variables.

### FIELD

The present invention relates to exhaust gas treatment systems for motor vehicles and especially to methods for detecting a manipulation of exhaust gas treatment systems.

### BACKGROUND INFORMATION

Modern SCR exhaust gas treatment systems (Selective Catalytic Reduction SCR) for denoxing (reducing the nitrogen oxide by a urea injection into the exhaust gas) provide legally prescribed monitoring of the system parameters relevant for a fault-free operation (onboard diagnosis). Within the scope of this onboard diagnosis, the control unit and its software carry out, among others, a plausibilization of the relevant system parameters with regard to compliance with physically meaningful limit values. This avoids, for example, an implausible exhaust gas temperature value from becoming part of the calculation of the SCR operating strategy.

For system-inherent parameters whose values result from the combination of different correction variables of the SCR control, it is furthermore checked whether the expected system reaction comes about following a system intervention. For instance, if the urea dosage is increased under defined conditions, a reduction in the nitrogen oxide emissions, measured by the nitrogen oxide sensor, is expected. If the expected reaction does not materialize, then further diagnosis functions for a defect detection may commence at the component level.

Technical devices in motor vehicles can be impermissibly manipulated in an attempt to achieve an advantageous operation for the driver. For example, an exhaust gas treatment device can be manipulated in order to improve the performance of the engine system or to reduce a material consumption, in particular of urea. This is achieved with the aid of professionally manufactured SCR emulators which act in a complex manner in their approach. These emulators can modify sensor values/setpoint values, e.g., the sensor variable of a system pressure in a vehicle, in such a way that the SCR system is active only to a limited extent or is no longer active at all. This makes it possible to reduce the maintenance expense in the vehicle operation and save money for the replenishment of urea at the expense of higher nitrogen oxide emissions. The conventional diagnosis functions are tricked by the emulated sensor signals, which makes it more difficult to detect the manipulation.

Generally, methods for a manipulation detection are rule-based. Rule-based manipulation monitoring methods have the disadvantage of being able to detect only known manipulation strategies or to catch only known manipulations. Such a defense strategy is therefore blind to novel manipulations. In addition, it is costly to capture a complex technical system with its dependencies in a control system and to set up corresponding rules for detecting a manipulation.

For example, the operating states for an exhaust gas treatment device are manifold due to their dynamic behavior, and it may sometimes be impossible to unequivocally allocate them to the presence of a manipulation, especially in system states that do not occur often.

### SUMMARY

According to the present invention, a computer-implemented method for detecting a manipulation of a technical device as well as a device and an exhaust gas treatment system, are provided.

Example embodiments of the present invention are disclosed herein.

According to a first aspect of the present invention, a computer-implemented method for detecting a manipulation of a technical device, in particular a technical device in a motor vehicle, in particular an exhaust gas treatment device, is provided. In accordance with an example embodiment of the present invention, the method includes the following steps:
Providing time characteristics of operating variables having one or more system variable(s) and/or at least one correction variable for an intervention in the technical device, which correspond to time series of values of the operating variables for consecutive time steps in each case;
Using a data-based manipulation detection model in each current time step in order to ascertain, as a function of input variables that include at least a portion of the operating variables, one or more output variable(s) which correspond(s) to at least a portion of the operating variables, the manipulation detection model including an autoencoder having a first recurrent neural network, a prediction model having a second recurrent neural network, and an evaluation module, the outputs of the autoencoder and the prediction model being combined with one another and then conveyed to an evaluation model for an ascertainment of the output variables, the manipulation detection model being trained to model current values of the output variables as a function of current values of the at least one portion of the operating variables;
Detecting an anomaly as a function of a modeling error for each one of the output variables;
Detecting a manipulation as a function of the detected anomalies.

Rule-based manipulation detection systems have the disadvantage that only known manipulation strategies are detectable and novel manipulation techniques are therefore unable to be discovered. In addition, the manipulation detection methods have gaps because complex technical systems such as exhaust gas treatment systems cannot be fully detected in a rule-based manner.

In accordance with the present invention, with the aid of a data-based manipulation detection model, the above procedure for detecting a manipulation of an exhaust gas treatment system makes it possible to learn the normal behavior of the technical device and to identify deviations from the normal behavior as a manipulation attempt. To this end, methods from the field of unsupervised learning are employed to learn, on the basis of recorded operating data from one or more technical device(s), how the technical device operates in a normal state. The machine learning methods have the capability of independently identifying dependencies and characteristics of the examined input signals that are important for the underlying task, without the need to use domain knowledge for this purpose, apart from the selection of the employed operating variables. Since a normal behavior of the technical device is learned, such a system makes it possible to detect even novel and currently unknown manipulation attempts.

The manipulation detection method according to the present invention starts out from characteristics of operating variables that are recorded while the technical device is in operation. In consecutive time steps, the manipulation detection model is used with the respective current values of the input variables, which include at least a portion of the operating variables. The operating variables may encompass one or more sensor variable(s) and/or one or more correction variable(s) by which the technical devices are operated, in particular the exhaust gas treatment device and the upstream internal combustion engine. At least a portion of the characteristics of the operating variables is preprocessed as input variables in an autoencoder with the aid of a first recurrent neural network and then processed further, e.g., via one or more linear layers (fully connected layer). For instance, the recurrent neural network may be embodied as an LSTM (Long Short-Term Memory) or a GRU (Gated Recurrent Unit) or variants thereof in order to be able to learn and/or take the time dynamics of the individual operating variable characteristics into account.

An autoencoder in the sense of this description denotes the architecture of a neural network in the form of an autoencoder. In contrast to the conventional understanding, this is meant to encompass also neural networks in which the input data differ from the output data of the autoencoder or in which the autoencoder is not exclusively designed or trained to reconstruct the input data.

In addition, the autoencoder may be developed as a variational autoencoder and have a latent feature space, which is developed with two linear feature space layers for imaging a mean value vector and a standard deviation vector, and the variational encoder is trained with the aid of a regularization term that induces the development of the feature space layers for imaging the mean value vector and a standard deviation vector during the training.

Variational autoencoders are mostly used as generative models. For this purpose, a regularization system forces a distribution in the latent space during the training (frequently a multivariant normal distribution). This has the benefit that a continuity exists in the latent space. For instance, a normal distribution is able to be realized by the regularization system. The latent feature space is realized via two linear layers (fully connected layers), of which one represents the mean value vector and the other the standard deviation. The variational autoencoder has the advantage that a forced continuity is to be expected in the latent space so that “similar” input points in the latent space lie “close” to one another. This is meant to achieve a better generalization capability of unseen data by the variational autoencoder.

In addition, a prediction model is used which, starting from the operating variable characteristics of at least a portion of the supplied operating variables, predicts a temporal development or a temporal characteristic of the operating variables. The prediction model includes a second recurrent network, which may furthermore be coupled with one or more linear layers (fully connected layer) on the output side. The operating variable characteristics are used as input variables only up to a time step before the current time step, that is to say, while the autoencoder receives the input variables for the current time step, the prediction model receives the values of the input variables for a preceding time step.

More specifically, in each current time step it is possible to supply the current values of first ones of the input variables to the autoencoder, and the values of second ones of the input variables for the preceding time step to the prediction model.

In accordance with an example embodiment of the present invention, the prediction model may be trained together with the other components of the manipulation detection model so that it learns what must be combined for the output of the autoencoder in order to obtain a desired output variable. The output variables are determined from the output of the autoencoder and from what the prediction model “deems important” from time step t−1. It may correspondingly be provided that in each current time step, the current values of the input variables are conveyed to the autoencoder, and the values of the input variables for the preceding time step are conveyed to the prediction model.

The one or the plurality of serially connected linear layers following the second recurrent network correspond(s) to fully connected layer(s) whose outputs are combined with the output of the variational autoencoder.

In particular, the outputs of the variational autoencoder and the prediction model may be summed and the result be processed with the aid of a neural network having one or more layers in order to model a time series of the operating variables. A further method consists of “lining up” the outputs next to one another by concatenating.

The training of the manipulation detection model is carried out as a whole. In the process, the output variables of the manipulation detection model, in particular together with the comparison variables that at least partially correspond to the input variables or are derived therefrom or which are modeled according to a regression ansatz, are entered into the error function together with the mean values and standard deviations, a portion of the error being calculated, e.g., per mean squared error, and a further portion being determined by the Kulback-Leibler regularization.

Moreover, the autoencoder may be pretrained, in particular using an error function such as a mean squared error and, in the case of a variational encoder, using a Kulback-Leibler regularization term. The further training of the entire manipulation detection model may subsequently be carried out with or without fixing the network parameters of the autoencoder.

Both the optional advance training of the autoencoder and the entire training of the manipulation detection model may take place across multiple epochs. The number of epochs may either be fixedly predefined or be determined by an abort criterion. In every epoch, all training data that indicate operating variable data of a normal behavior of the exhaust gas treatment device are processed once by the autoencoder. The operating variables are preferably split up into time intervals which, for example, include between 500 and 3000 time steps. For each of these training epochs, the time intervals are able to be generated anew and randomly.

If the autoencoder is trained in advance, the output of the autoencoder together with the calculated matrices for the mean value and the standard deviation of the intermediate layer of the variational encoder and the actual values are entered into error function F. The error function determines the modeling error, the mean square error, the root mean square error or, alternatively, the Huber loss or further functions that indicate a numerical deviation between the actual values of the operating variables at time step t and the output variables of the manipulation detection model.

To force the distribution characteristic of the latent space of the variational autoencoder, a Kulback-Leibler regularization for the modeling is taken into account in which the mean value is entered into the standard deviation, as known from the training of a variational autoencoder. In a backpropagation process, the error value is then used for adapting the weights of the network according to an optimization strategy. A gradient descent method such as SGD, ADAM, ADAMW, RMSProp or AdaGrad common for neural networks is able to be used for this purpose.

According to one embodiment of the present invention, the first and second input variables may include a portion of the operating variables that is identical, partially identical or that differs, and the output variables include a portion of the operating variables that is identical to, partially identical to or that differs from the first and/or second input variables, and the modeling error is determined as a function of the modeled current values of the output variables and the current values of the operating variables corresponding to the output variables.

In other words, in a regression ansatz, the output variables may include variables that are not part of the input variables but include further operating variables that are not used as input variables.

In particular, the variational autoencoder may have a latent feature space which is developed with two linear feature space layers for imaging a mean value vector and a standard deviation vector, the modeling error furthermore being determined as a function of the modeled current values of the mean value vector and the standard deviation vector.

In addition, the modeling error is able to be ascertained with the aid of a predefined error function, which particularly is based on a mean squared error (mean square deviation), a Huber loss function or a root mean squared error between the respective current values of the second portion of the operating variables and the output variables.

It may be provided that for multiple time intervals of an evaluation interval, a total error is determined from a plurality of modeling errors for a number of consecutive time steps of each of the output variables, in particular by summing the modeling errors, and an anomaly for the particular time interval is identified as a function of an exceeding of a predefined evaluation percentile for the respective output variable by the total error.

When utilizing the manipulation detection model, the operating variables are conveyed to the variational autoencoder and the prediction model for an interval having a number of time steps in order to obtain a corresponding resulting output variable. With the aid of an error function, an anomaly score for each time step is assigned to this output variable. In particular, the error function can determine a modeling error and to sum it for each output variable across the number of time steps of the time interval to form a total error for the respective output variable. The total error resulting therefrom for each one of the output variables results in an error matrix for each time block and each operating variable, from which a percentile value is calculated. For example, for each operating variable, a percentile in the range of 99.9% to 99.99% is able to be calculated. The percentile is stored and evaluated in the evaluation phase in order to detect a manipulation. A manipulation is detectable especially if the percentile value for at least one output variable exceeds a predefined evaluation percentile value.

More specifically, a manipulation of the technical device is able to be detected when the share of anomalies during the time intervals of the evaluation interval exceeds a predefined share threshold value.

The evaluation percentile value is able to be determined for each operating variable in that, based on a characteristic of operating variables of a predefined validation dataset for a correct operation of the technical device for multiple time intervals of an evaluation interval for a number of consecutive time steps in each case, a total error is determined from multiple modeling errors for the respective multiple time steps, in particular by summing the modeling errors, and an error matrix is set up from the output variables and the assigned total errors, and a percentile value as the evaluation percentile value, in particular a 99.9% percentile, is determined for each output variable.

According to one embodiment of the present invention, the technical device may include an exhaust gas treatment device, and the input vector as the correction variable includes a correction variable for a urea injection system.

It may furthermore be provided that a detected manipulation is signaled or the technical device is operated as a function of the detected manipulation.

According to a further aspect of the present invention, a method for training a data-based manipulation detection model as a function of characteristics of operating variables of a technical device is provided, the operating variables including one or more system variable(s) and/or at least one correction variable for an intervention in the technical device and corresponding to time series of values of the operating variables for consecutive time steps in each case, the manipulation detection model including an autoencoder which has a first recurrent neural network, a prediction model which has a second recurrent neural network, and an evaluation model, the outputs of the autoencoder and of the prediction model being combined with one another and then conveyed to an evaluation model for an ascertainment of the output variables, the manipulation detection model being trained to model current values of output variables that correspond to one or more of the operating variable(s) as a function of current values of the at least a portion of the operating variables.

According to a further aspect of the present invention, a device for a manipulation detection of a technical device is provided, in particular a technical device in a motor vehicle, in particular an exhaust gas treatment device. In accordance with an example embodiment of the present invention, the device is developed:
to supply time characteristics of operating variables with one or more system variable(s) and/or at least one correction variable for an intervention in the technical device, which correspond to time series of values of the operating variables for consecutive time steps in each case;
to use a data-based manipulation detection model in each current time step to determine one or more output variable(s) that correspond to at least a portion of the operating variables as a function of input variables which include at least a portion of the operating variables, the manipulation detection model including a variational autoencoder having a first recurrent neural network, a prediction model having a second recurrent neural network, and an evaluation model, the outputs of the variational autoencoder and of the prediction model being combined with one another and then conveyed to an evaluation model for an ascertainment of the output variables, the manipulation detection model being trained to model current values of the output variables as a function of current values of at least a portion of the operating variables;
to detect an anomaly as a function of a modeling error for each one of the output variables; and
to detect a manipulation as a function of the detected anomalies.

### BRIEF DESCRIPTION OF THE DRAWINGS

Below, embodiments will be described in greater detail with the aid of the figure.

FIG. 1 shows a schematic representation of an exhaust gas treatment device as an example of a technical system.

FIG. 2 shows a schematic representation of a network structure of a manipulation detection model based on an evaluation of time series of input vectors for use in a manipulation detection, in accordance with an example embodiment of the present invention.

FIG. 3 shows a flow diagram to illustrate a method for a manipulation detection of the exhaust gas treatment device of FIG. 1, in accordance with an example embodiment of the present invention.

### DETAILED DESCRIPTION OF EXAMPLE EMBODIMENTS

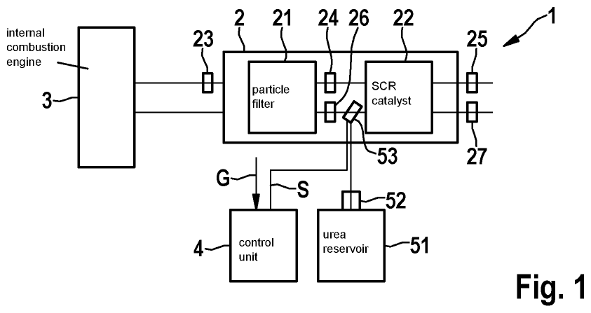

FIG. 1 shows a schematic representation of an exhaust gas treatment system 2 for a motor system 1 having an internal combustion engine 3. Exhaust gas treatment device 2 is configured for the exhaust gas treatment of combustion gas of internal combustion engine 3. Internal combustion engine 3 may be embodied as a Diesel engine.

Exhaust gas treatment device 2 has a particle filter 21 and an SCR catalyst 22. The exhaust gas temperature is measured upstream from particle filter 21, downstream from particle filter 21 and downstream from SCR catalyst 22 by a respective temperature sensor 23, 24, 25, and the NOₓ content is measured upstream and downstream from SCR catalyst 22 by a respective NOₓ sensor 26, 27 and processed in a control unit 4. The sensor signals are supplied to the control unit as system variables G.

A urea reservoir 51, a urea pump 52, and a controllable injection system 53 for the urea are provided. Injection system 53 makes it possible to convey, controlled by control unit 4 with the aid of a correction variable S, urea in a predefined quantity into the combustion exhaust gas upstream from SCR catalyst 22.

Using conventional methods, control unit 4 controls the supply of urea upstream from SCR catalyst 22 by specifying a correction variable for injection system 53 for achieving the best possible catalyzation of the exhaust gas so that the nitrogen oxide content is reduced as much as possible.

Conventional manipulation devices manipulate sensor signals and/or correction signals in an attempt to reduce the consumption of urea or to stop it completely.

Although such manipulations are able to be identified by rule-based monitoring of operating states of the exhaust gas treatment device, not all corresponding impermissible operating states can be checked in this manner. A manipulation detection method based on a manipulation detection model is therefore provided, which is able to be carried out in control unit 4. The method may be implemented in control unit 4 in the form of software and/or hardware.

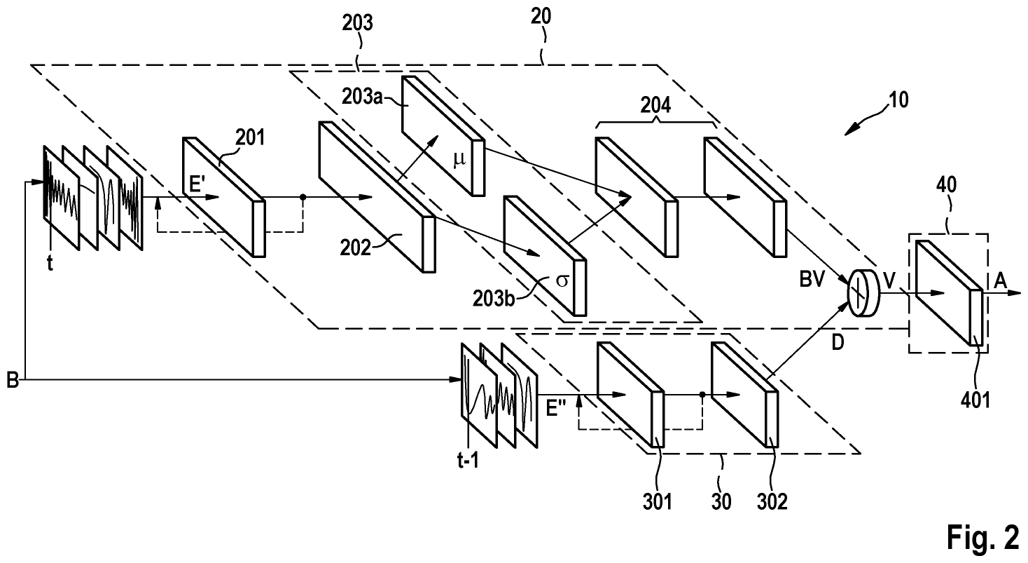

FIG. 2 shows a schematic representation of a manipulation detection model 10, which is able to process characteristics of input variables E in order to generate one or more output variable(s) A. The input variables may include operating variables B, which have system variables G and/or correction variables S. The input variables are evaluated time step by time step in order to reconstruct the current value of one or more operating variable(s) B and to make them available as corresponding output variables. In a regression ansatz, the output variables may include operating variables that are not part of the input variables.

To this end, the manipulation detection model may include an autoencoder to which one or more first input variable(s) is/are conveyed and which is embodied as variational autoencoder 20 in the illustrated exemplary embodiment. On the input side, variational autoencoder 20 has a first recurrent neural network 201. First recurrent neural network 201 may be developed as an LSTM or GRU or variants thereof, for instance. First recurrent neural network 201 is utilized for learning the time dynamics of the characteristics of first input variables E′.

The output of first recurrent neural network 201 is output to one or more serial first fully connected layer(s) 202 (linear layers, i.e., neuron layers without non-linear activation functions). The one or the plurality of first fully connected layer(s) 202 form(s) a latent feature space 203 of the variational autoencoder on the output side.

The latent feature space represents the distribution of features of the characteristics of first input variables E′ in that variational autoencoder 20 is embodied as a generative model. Toward this end, the corresponding distribution in latent feature space 203 is forced with the aid of a regularization term. The regularization term is specified in such a way that the distribution of the features of the first input variables in latent feature space 203 corresponds to a multivariate normal distribution. Latent feature space 203 may be embodied as two linear feature space layers for this purpose, i.e., neuron layers without non-linear activation functions, so that one of the feature space layers 203a represents the mean value vector μ and the other feature space layer 203b represents the standard deviation σ. The variational autoencoder is used to obtain a greater generalizability of the input variable characteristics not imaged by training data in the configuration of the manipulation detection model.

The mean value vector p and the standard deviation σ represented in feature space layers 203a, 203b are further processed with the aid of one or more sampling layer(s) 204 so that the latent features learned by the autoencoder are sampled and made available.

In a prediction model 30, one or more second input variable(s) E″, which are based on all or a portion of operating variables B in a preceding time step t−1, are processed. This processing is then combined with the output of the autoencoder so that the entire manipulation detection model has access to the information from both previous components. The second input variables may be identical to the first input variables or correspond to a subset thereof, or they may differ from the first input variables. In other words, in a time step t, the current values of the first input variables are conveyed to the autoencoder and at a preceding time step t−1, the values of second input variables E″ are conveyed to prediction model 30.

This particularly makes it possible to use operating variables on the input side which, although important for their modeling due to their dependencies on other signals, are not relevant for the actual anomaly detection and thus occur only as part of the first and/or second input variables. In addition, it is possible to model output variables A that are not part of input variables E′, E″ used on the input side. In this way, output variables A are able to be modeled per regression ansatz and to be compared to the actual operating variables B that had not been previously used on the input side.

Prediction model 30 is trained together with the autoencoder and therefore capable of making an output available that compensates/supplements the output of the autoencoder. In contrast to autoencoder 20, prediction model 30 therefore has access to the values of the second input variables at the preceding time step t−1. For this purpose, prediction model 30 initially processes the characteristics of second input variables E″ up to a preceding time step t−1 using a second recurrent network. The output of second recurrent neural network 301 is coupled with one or more second fully connected layer(s) 302 for this purpose.

The output of the one or the plurality of fully connected layer(s) 302 of prediction model 30 is combined with the output of sampling layers 204 (operating variable vector BV) of variational autoencoder 20. The outputs of variational autoencoder 20 and of prediction model 30 are particularly able to be summed in a summation block or concatenated for this purpose in order to obtain a result vector V.

Result vector V may in turn be processed in an evaluation model 40, which has one or more third fully connected layer(s) 401 for generating as a final output a reconstruction of one or more of operating variable(s) B as output variables A. First input variables E′ for variational autoencoder 20 correspond to the current (time step t) values of the first input variables, while the values of second input variables E″, delayed by a time step, are applied at the input side of prediction model 30.

The goal of the manipulation detection model is to decide over a longer period of time, e.g., a normal trip of a vehicle, whether a manipulation device was used in this vehicle. Operating variables B are therefore recorded using a predefined time raster, e.g., 100 ms, 500 ms or 1 s. It may furthermore be sufficient to evaluate the manipulation detection model only during a certain percentage of a trip in order to detect a manipulation attempt. Prior to being used in the manipulation detection model, operating variables B are normalized or standardized in signaling terms, in particular using the identical methodology as during the training of the manipulation detection model. The preprocessing of variables B should be normalized in a robust manner and may include further steps for cleansing the data, e.g., the handling of missing values and the extracting of relevant time intervals, the smoothing of data, or other types of transformations.

For example, the manipulation detection model is able to generate a model for a NOx sensor whose sensor signal can be manipulated. Because a precise regression model may be set up for the NOₓ sensor, simple manipulation ansatzes, e.g., the replaying of realistic NOₓ sensor values, are reliably detectable because the manipulation detection model 10 has learned the input and output behaviors of other operating variables and is therefore not easily deceived by a simple replay model. The compiling of the input-side operating variables B and the output-side output variables and also the selection of first input variables E′ and second input variables E″ is implemented with the aid of domain knowledge.

For one or more of the operating variable(s) known to be susceptible to manipulations, it may be useful to select a regression ansatz in which an output variable A is generated that was not previously used as input variable E′, E″ or as first E′ input variables and/or second input variables E″ on the input side.

The training of the manipulation detection model may be carried out across multiple epochs. The number of epochs may either be fixedly predefined or be defined by an abort criterion. In each epoch, the neural network processes all training data one time. The training data are split up into batches which have time series of operating variables that include between 100 and 5000, and preferably between 500 and 3000 values in each case. The batches may be newly or randomly generated prior to each epoch.

Autoencoder 20 and/or prediction model 30 are able to be pretrained, i.e., trained before the entire training of the manipulation detection model takes place. The training of variational autoencoder 20 is performed based on characteristics of first input variables E′ and carried out with the aid of an error function F that considers the output of the variational autoencoder together with the calculated matrices of the mean values and standard deviations and the actual values of the output variables. The error function includes the modeling error (the deviation between the output variables and the ascertained actual corresponding operating variables) as a mean squared error (MSE) or the root mean squared error (RMSE) or possibly the Huber loss, or other deviation functions that calculate a numerical deviation between the actual values for current time step t and the output variables of the manipulation detection model. To force the distribution characteristics of the latent feature space, a Kullback-Leibler regularization is added in a weighted manner to the modeling error, which is then entered into the mean value vector and the standard deviation vector, as is conventional in the related art.

With the aid of a backpropagation, the error value ascertained in this way is propagated back to the values of the input variables or operating variables according to the training data, which makes it possible to adapt the weights of the network according to an optimization strategy. To this end, common gradient descent methods, e.g., SGD, ADAM, ADAMW, RMSprop or AdaGrad may be used.

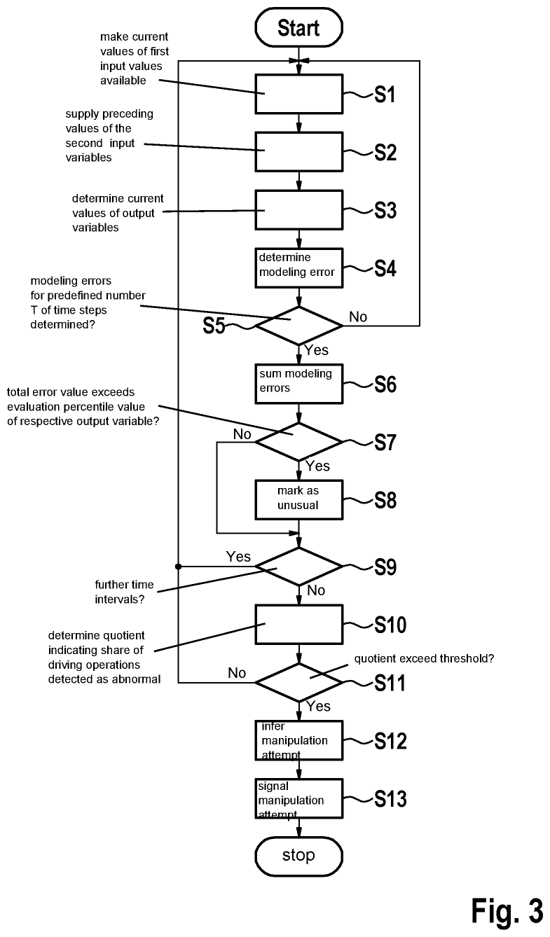

An application of the manipulation detection model 10 for signaling a manipulation of an exhaust gas treatment system is described in greater detail in FIG. 3.

For an evaluation of manipulation detection model 10, the current values of the first input variables E (part of operating variables B) are made available to variational autoencoder 20 in step S1 for each time step.

In step S2, the preceding values of the second input variables (the same or another part of the operating variables) are supplied to prediction model 30 as input variables delayed by one time step.

In step S3, the current values of the output variables are determined in each time step by applying manipulation detection model 10. Output variables A correspond to the/a part of operating variables B.

In step S4, a modeling error is determined for the current time step for all output variables as a deviation between the modeled value of the output variable and the actual value of the operating variable corresponding to the output variable and buffered. The underlying error function considers the output variables, the operating variables corresponding to the output variables, the mean value vector, and the standard deviation vector of variational autoencoder 20. The error function, for example, may be used to calculate the mean squared error between the reconstruction variables and the operating variables (or also an RMSE or a Huber loss).

In step S5, it is checked whether modeling errors for the predefined number T of time steps in the examined time block of the evaluation interval have been determined. If this is the case (alternative: yes), the method continues with step S6; in the other case, a return to step S1 takes place for the next time step.

In step S6, the modeling errors of the different time steps of the previously examined time interval are summed for each one of the output variables so that individual total errors are obtained. This makes is possible to ascertain a modeling error for each output variable A based on characteristics of operating variables of the exhaust gas treatment system, and this modeling error can be summed across a number T of time steps so that a total error may be obtained.

In step S7, it is checked for each output variable whether the corresponding total error value exceeds an evaluation percentile value of the respective output variable. If this is the case (alternative: yes), then the corresponding signal for the examined time interval of the respective output variable is marked as unusual in step S8. The examined time interval may be marked as unusual or an anomaly overall if the total error for at least one of the output variables was determined to be unusual in the time interval.

The evaluation percentile value is able to be specified individually for each output variable. The evaluation percentile value may result prior to the actual evaluation phase based on validation data from a validation dataset that indicates characteristics of operating variables of a non-manipulated, correctly working exhaust gas treatment system. In this way, an evaluation percentile value resulting from an error matrix is ascertainable for each output variable. To this end, for a number of time steps, the errors are summed in order to generate a total error value in signaling terms. This is done repeatedly, and a percentile value, e.g., a 99.9% percentile, is determined from the resulting total error values. This value is able to be calibrated (depending on whether it is more important to avoid false positives or to achieve the highest possible detection rate). Thus, a fixed evaluation percentile value is ascertained for each output variable against which comparisons are then carried out in the evaluation phase.

In step S9, it is checked whether further time intervals must be examined in the evaluation interval. If this is not the case (alternative: no), then the method continues with step S10, whereas a return to step S1 takes place for the next time interval in the other case.

During the method, it is possible to store the total number of examined time intervals in a counter, and a further counter may store the number of time intervals that were marked as unusual.

In step S10, the detected anomalies for consecutive evaluation intervals, e.g., while driving, are summed and this sum is divided by the number of total evaluation intervals while driving. This quotient indicates the share of driving operations that was detected as abnormal.

In step S11, it is checked whether the quotient exceeds a predefined share threshold value. If the quotient exceeds the predefined share threshold value (alternative: yes), then a manipulation attempt may be inferred in step S12, and this fact be signaled accordingly in step S13. In the other case (alternative: no), the method continues with step S1.

1-15. (canceled)

16. A computer-implemented method for detecting a manipulation of a technical device, the method comprising the following steps:
providing time characteristics of operating variables having one or more system variables and/or at least one correction variable for an intervention in the technical device, which correspond to time series of values of the operating variables for consecutive time steps in each case;
using a data-based manipulation detection model in each current time step to ascertain one or more output variables which correspond to at least a portion of the operating variables as a function of input variables that include at least a portion of the operating variables, the manipulation detection model including an autoencoder having a first recurrent neural network, a prediction model having a second recurrent neural network, and an evaluation model, outputs of the autoencoder and the prediction model being combined with one another and then conveyed to an evaluation model for an ascertainment of the output variables, the manipulation detection model being trained to model current values of the output variables as a function of current values of the at least one portion of the operating variables;
detecting an anomaly as a function of a modeling error for each one of the output variables;
detecting a manipulation as a function of the detected anomalies.

17. The method as recited in claim 16, wherein the technical device is an exhaust gas treatment device in a motor vehicle.

18. The method as recited in claim 16, wherein the autoencoder is a variational autoencoder and has a latent feature space which is developed with two linear feature space layers for imaging a mean value vector and a standard deviation vector, and the variational autoencoder is trained using a regularization term, which induces development of the feature space layers for imaging the mean value vector and a standard deviation vector during the training.

19. The method as recited in claim 16, wherein in each current time step, current values of first ones of the input variables are supplied to the autoencoder, and values of the second ones of the input variables for a preceding time step are supplied to the prediction model.

20. The method as recited in claim 19, wherein the first ones of the input variables and the second ones of the input variables each include a portion of the operating variables that is identical, partially identical or that differs, and the output variables include a portion of the operating variables that is identical to, partially identical to or that differs from the first and/or second input variables, and the modeling error is determined as a function of the modeled current values of the output variables and the current values of the operating variables corresponding to the output variables.

21. The method as recited in claim 20, wherein the variational autoencoder has a latent feature space which is developed with two linear feature space layers for imaging a mean value vector and a standard deviation vector, and the modeling error furthermore is determined as a function of the modeled current values of the mean value vector and the standard deviation vector.

22. The method as recited in claim 20, wherein the modeling error is ascertained using a predefined error function, which is based on a mean squared error or a Huber loss function or a root mean squared error between the current values of the operating variables and the corresponding output variables.

23. The method as recited in claim 20, wherein for multiple time intervals of an evaluation interval, a total error is determined for a number of consecutive time steps of each one of the output variables, from a plurality of modeling errors, by summing the modeling errors, and an anomaly for each of the time intervals is identified as a function of an exceeding of a predefined evaluation percentile for the respective output variable by the total error.

24. The method as recited in claim 23, wherein a manipulation of the technical device is detected when a share of anomalies during the time intervals of the evaluation interval exceeds a predefined share threshold value.

25. The method as recited in claim 23, wherein the evaluation percentile value for each operating variable is determined in that, based on a characteristic of operating variables of a predefined validation dataset for a correct operation of the technical device for multiple time intervals of an evaluation interval for a number of consecutive time steps in each case, a total error is determined from multiple modeling errors for the respective multiple time intervals, by summing the modeling errors, and an error matrix is set up from the output variables and the assigned total errors, and a percentile value as the evaluation percentile value is determined for each output variable.

26. The method as recited in claim 25, wherein the percentile value is 99.9%.

27. The method as recited in claim 16, wherein the technical device includes an exhaust gas treatment device, and an input vector as the correction variable includes a correction variable for a urea injection system.

28. The method as recited in claim 16, wherein a detected manipulation is signaled, or the technical device is operated as a function of the detected manipulation.

29. A method for training a data-based manipulation detection model as a function of characteristics of operating variables of a technical device, the operating variables including one or more system variables and/or at least one correction variable for an intervention in the technical device and corresponding to time series of values of the operating variables for consecutive time steps in each case, the manipulation detection model including an autoencoder that has a first recurrent neural network, a prediction model that has a second recurrent neural network, and an evaluation model, outputs of the autoencoder and the prediction model being combined with one another and then conveyed to an evaluation model for an ascertainment of the output variables, the method comprising:
training the manipulation detection model to model current values of output variables that correspond to one or more of the operating variables as a function of current values of the at least one portion of the operating variables.

30. A device for detecting a manipulation of a technical device in a motor vehicle, the technical device being an exhaust gas treatment device, the device being configured to:
supply time characteristics of operating variables having one or more system variables and/or having at least one correction variable for an intervention in the technical device which correspond to time series of values of the operating variables for consecutive time steps;
use a data-based manipulation detection model in each current time step to ascertain one or more output variables that correspond at least to a portion of the operating variables as a function of input variables that include at least a portion of the operating variables, the manipulation detection model including an autoencoder having a first recurrent neural network, a prediction model having a second recurrent neural network, and an evaluation model, outputs of the autoencoder and of the prediction model being combined with one another and then conveyed to an evaluation model for an ascertainment of the output variables, the manipulation detection model being trained to model current values of the output variables as a function of current values of the at least one portion of the operating variables;
detect an anomaly as a function of a modeling error for each one of the output variables;
detect a manipulation as a function of the detected anomalies.

31. A non-transitory machine-readable memory medium on which are stored instructions for detecting a manipulation of a technical device, the instructions, when executed by a computer, causing the computer to perform the following steps:
providing time characteristics of operating variables having one or more system variables and/or at least one correction variable for an intervention in the technical device, which correspond to time series of values of the operating variables for consecutive time steps in each case;
using a data-based manipulation detection model in each current time step to ascertain one or more output variables which correspond to at least a portion of the operating variables as a function of input variables that include at least a portion of the operating variables, the manipulation detection model including an autoencoder having a first recurrent neural network, a prediction model having a second recurrent neural network, and an evaluation model, outputs of the autoencoder and the prediction model being combined with one another and then conveyed to an evaluation model for an ascertainment of the output variables, the manipulation detection model being trained to model current values of the output variables as a function of current values of the at least one portion of the operating variables;
detecting an anomaly as a function of a modeling error for each one of the output variables;
detecting a manipulation as a function of the detected anomalies.
